(19) United States
(12) Patent Application Publication
(10) Pub. No.: US 2015/0301829 A1
(43) Pub. Date: Oct. 22, 2015

(54) SYSTEMS AND METHODS FOR MANAGING BRANCH TARGET BUFFERS IN A MULTI-THREADED DATA PROCESSING SYSTEM

(71) Applicants: JEFFREY W. SCOTT, AUSTIN, TX (US); WILLIAM C. MOYER, DRIPPING SPRINGS, TX (US); ALISTAIR P. ROBERTSON, GLASGOW (GB)

(72) Inventors: JEFFREY W. SCOTT, AUSTIN, TX (US); WILLIAM C. MOYER, DRIPPING SPRINGS, TX (US); ALISTAIR P. ROBERTSON, GLASGOW (GB)

(21) Appl. No.: 14/256,020

(22) Filed: Apr. 18, 2014

(51) Int. Cl. G06F 9/38; G06F 9/30

(52) U.S. Cl. CPC G06F 9/3806; G06F 9/30058

(57) ABSTRACT

A data processing system includes a processor configured to execute processor instructions of a first thread and processor instructions of a second thread, a first branch target buffer (BTB) corresponding to the first thread, a second BTB corresponding to the second thread, storage circuitry configured to store a borrow enable indicator corresponding to the first thread which indicates whether borrowing is enabled for the first thread, and control circuitry configured to allocate an entry for a branch instruction executed within the first thread in the first branch target buffer but not the second branch target buffer if borrowing is not enabled by the borrow enable indicator and in the first branch target buffer or the second branch target buffer if borrowing is enabled by the borrow enable indicator and the second thread is not enabled.

### BACKGROUND

1. Field

This disclosure relates generally to data processors, and more specifically, to managing branch target buffers in a multi-threaded data processing system.

2. Related Art

Branch target buffers (BTBs) are typically used within data processing systems to improve branch performance. BTBs act as a cache of recent branches and can accelerate branches by providing a branch target address prior to execution of the branch instruction, which allows a processor to more quickly begin execution of instructions at the branch target address. The greater the number of entries within a BTB, the more branches may be cached and the greater the performance increase, but at a cost of circuit area and power. Also, if the BTB does not include sufficient entries, constant overriding of BTB entries will occur thus resulting in reduced performance. Furthermore, multi-threaded processors add additional challenges since it is desirable for each thread to have use of a BTB for improved performance. Thus there is a need for an improved BTB for use within a multi-threaded system which does not significantly increase area or power.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 illustrates, in block diagram form, a data processing system having a branch target buffer in accordance with one embodiment of the present invention;

FIG. 2 illustrates, in block diagram form, a portion of a central processing unit (CPU) of the data processing system of FIG. 1 in accordance with one embodiment of the present invention;

FIG. 3 illustrates, in diagrammatic form, a branch control and status register in accordance with one embodiment of the present invention;

FIG. 4 illustrates in block diagram form a portion of the branch target buffers of FIG. 1 in accordance with one embodiment of the present invention; and

FIG. 5 illustrates, in flow diagram form, a method of operating the branch target buffers of FIG. 4, in accordance with one embodiment of the present invention.

### DETAILED DESCRIPTION

In a multi-threaded data processing system, in order to improve branch performance for each thread, each thread has an associated small branch target buffer (BTB). Therefore, in a multi-threaded system capable of executing N threads, N smaller BTBs may be present within the system, each associated with an executing thread. When each of the multiple threads are enabled, each thread has private use of its corresponding BTB. However, when fewer than all threads are enabled, an enabled thread may utilize the unused BTBs of other disabled threads. In this manner, the size of the BTB of the enabled thread may be effectively scaled, when possible, to allow for improved branch performance within the thread.

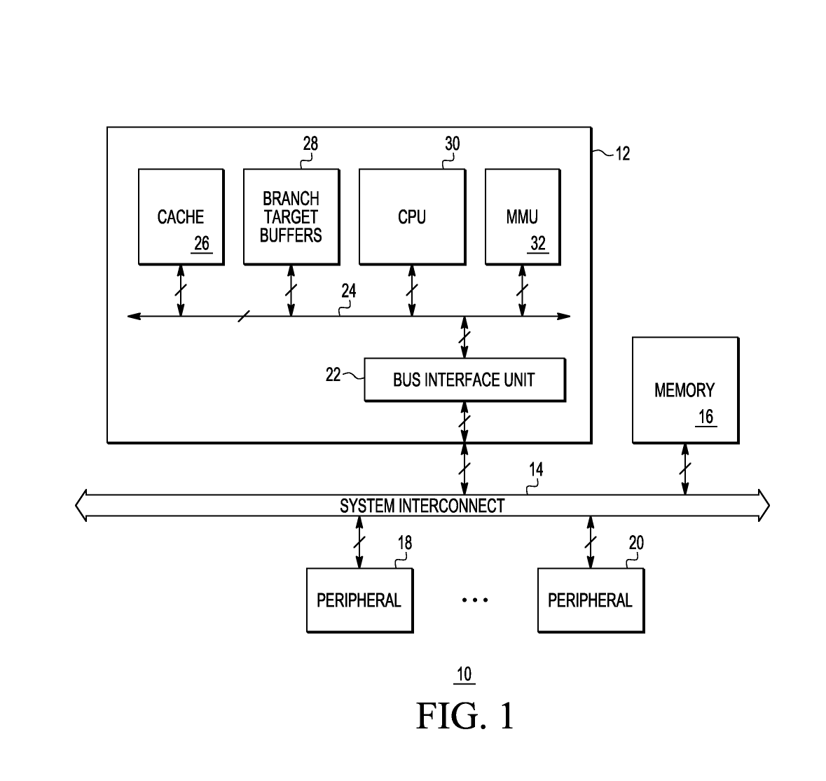

FIG. 1 illustrates, in block diagram form, a multi-threaded data processing system 10 capable of executing multiple threads. As used herein, it will be assumed that data processing system 10 is capable of executing up to two threads, thread0 and thread1. Data processing system 10 includes a processor 12, a system interconnect 14, a memory 16 and a plurality of peripherals such as a peripheral 18, a peripheral 20 and, in some embodiments, additional peripherals as indicated by the dots in FIG. 1 separating peripheral 18 from peripheral 20. Memory 16 is a system memory that is coupled to system interconnect 14 by a bidirectional conductor that, in one form, has multiple conductors. In the illustrated form each of peripherals 18 and 20 is coupled to system interconnect 14 by bidirectional multiple conductors as is processor 12. Processor 12 includes a bus interface unit (BIU) 22 that is coupled to system interconnect 14 via a bidirectional bus having multiple conductors. BIU 22 is coupled to an internal interconnect 24 via bidirectional conductors. In one embodiment, internal interconnect 24 is a multiple-conductor communication bus. Coupled to internal interconnect 24 via respective bidirectional conductors is a cache 26, branch target buffers (BTBs) 28, a central processing unit (CPU) 30 and a memory management unit (MMU) 32. CPU 30 is a processor for implementing data processing operations. Each of cache 26, BTBs 28, CPU 30 and MMU 32 are coupled to internal interconnect 24 via a respective input/output (I/O) port or terminal.

In operation, processor 12 functions to implement a variety of data processing functions by executing a plurality of data processing instructions. Cache 26 is a temporary data store for frequently-used information that is needed by CPU 30. Information needed by CPU 30 that is not within cache 26 is stored in memory 16. MMU 32 controls accessing of information between CPU 30 and cache 26 and memory 16.

BIU 22 is only one of several interface units between processor 12 and the system interconnect 14. BIU 22 functions to coordinate the flow of information related to instruction execution including branch instruction execution by CPU 30. Control information and data resulting from the execution of a branch instruction are exchanged between CPU 30 and system interconnect 14 via BIU 22.

BTBs 28 includes multiple BTBs, one for each possible thread which may be enabled within data processing system 10, and each includes a plurality of entries. Each of the entries with a given BTB corresponds to a fetch group of branch target addresses associated with branch instructions that are executed within the corresponding thread by the CPU 30. Therefore, CPU 30 selectively generates branch instruction addresses which are sent via internal interconnect 24 to BTBs 28. Each BTB within BTBs 28 contains a subset of all of the possible branch instruction addresses that may be generated by CPU 30. In response to receiving a branch instruction address from CPU 30, BTBs 28 provides a hit indicator from an appropriate BTB within BTBs 28 to CPU 30. If the hit indicator is asserted, indicating a hit occurred within BTBs 28, a branch target address is also provided from the appropriate BTB to CPU 30. CPU 30 may then begin instruction fetch and execution at the branch target address.

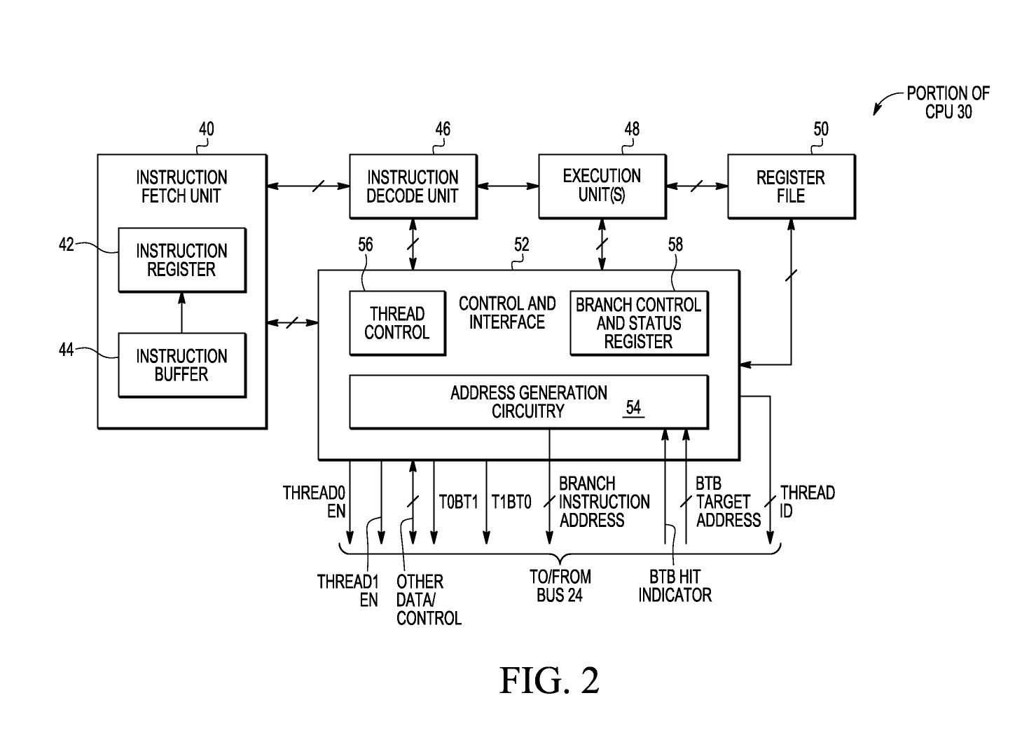

Illustrated in FIG. 2 is a detailed portion of CPU 30 of FIG. 1 that relates to the execution of instructions and the use of BTBs 28. An instruction fetch unit 40 is illustrated as including both an instruction buffer 44 and an instruction register 42. The instruction buffer 44 has an output that is connected to an input of instruction register 42. A multiple conductor bidirectional bus couples a first output of instruction fetch unit 40 to an input of an instruction decode unit 46 for decoding fetched instructions. An output of instruction decode unit 46 is coupled via a multiple conductor bidirectional bus to one or more execution unit(s) 48. The one or more execution unit(s) 48 is coupled to a register file 50 via a multiple conductor bidirectional bus. Additionally, instruction decode unit 46, one or more execution unit(s) 48, and register file 50 is coupled via separate bidirectional buses to respective input/output terminals of a control and interface unit 52 that interfaces to and from internal interconnect 24.

The control and interface unit 52 has address generation circuitry 54 having a first input for receiving a BTB Hit Indicator signal via a multiple conductor bus from the BTBs 28 via internal interconnect 24. Address generation circuitry 54 also has a second input for receiving a BTB Target Address via a multiple conductor bus BTBs 28 via internal interconnect 24. Address generation circuitry 54 has a multiple conductor output for providing a branch instruction address to BTBs 28 via internal interconnect 24.

Control and interface circuitry 52 includes a thread control unit 56 which controls the enabling and disabling of thread0 and thread1. Thread control unit 56 provides a thread0 enable signal (thread0 en), which, when asserted, indicates that thread0 is enabled, to BTBs 28 by way of internal interconnect 24. Thread control unit 56 provides a thread1 enable (thread1 en) signal, which, when asserted, indicates that thread1 is enabled, to BTBs 28 by way of internal interconnect 24. Thread control 56 selects an enabled thread for execution by CPU 30. If a thread is disabled, it cannot be selected for execution. Thread control 56 controls the execution of the enabled threads, such as when to start and stop execution of a thread. For example, thread control 56 may implement a round robin approach in which each thread is given a predetermined amount of time for execution. Alternatively, other thread control schemes may be used. Control and interface circuitry 52 also provides a thread ID to BTBs 28 by way of internal interconnect 24 which provides an indication of which thread is currently executing.

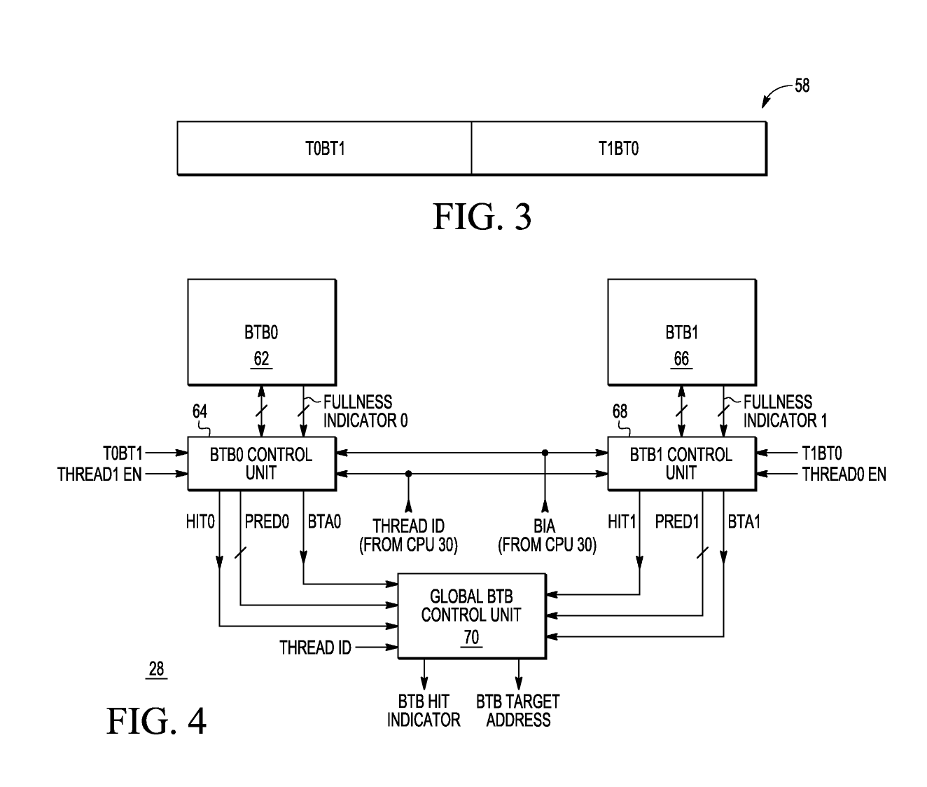

Control and interface circuitry 52 also includes a branch control and status register 58 which may be used to store control and status information for BTBs 28 such as control bits T0BT1 and T0BT2. These control bits may be provided to BTBs 28 by way of internal interconnect 24. Note that branch control and status register 58 will be described in further detail in reference to FIG. 3 below. Other data and control signals can be communicated via single or multiple conductors between control and interface unit 52 and internal interconnect 24 for implementing data processing instruction execution, as required.

In the illustrated form of this portion of CPU 30, control and interface unit 52 controls instruction fetch unit 40 to selectively identify and implement the fetching of instructions including the fetching of groups of instructions. Instruction decode unit 46 performs instruction decoding for one or more execution unit(s) 48. Register file 50 is used to support one or more execution unit(s) 48. Within control and interface unit 52 is address generation circuitry 54. Address generation circuitry 54 sends out a branch instruction address (BIA) to BTBs 28. In response to the branch instruction address, a BTB hit indicator is provided to CPU 30, and, if asserted, a BTB target address is also provided to CPU 30. The BTB target address is used by CPU 30 to obtain an operand at the target address from either cache 26 or from memory 16 if the address is not present and valid within cache 26.

FIG. 3 illustrates, in diagrammatic form, branch control and status register 58 in accordance with one embodiment of the present invention. Register 58 is configured to store borrow enable control bits. In the illustrated embodiment, these borrow enable control bits include a T0BT1 control bit which, when asserted (e.g. is a logic level 1), indicates that thread0 may borrow thread1's BTB when thread 1 is disabled and a T1BT0 control bit which, when asserted (e.g. is a logic level 1), indicates that thread1 may borrow thread0's BTB when thread0 is disabled. These control bits may be provided to BTBs 28. In one embodiment, branch control and status register 58 includes a borrow enable control bit corresponding to each BTB in BTBs 28 which indicates whether or not borrowing is enabled for the corresponding BTB. In this embodiment, the borrow enable control bit for a BTB may indicate whether or not its entries can be borrowed by another thread. Alternatively, the borrow enable control bit for a BTB may indicate whether its entries can be borrowed by one or more particular threads. In this case, register 58 may store multiple borrow enable control bits for each BTB to indicate whether borrowing is enabled from that BTB by a particular thread.

FIG. 4 illustrates, in block diagram form, a detailed portion of BTBs 28 of FIG. 1. In the illustrated embodiment, BTBs 28 includes two BTBS, BTB0 62 and BTB1 66. BTB0 corresponds to the private BTB of thread0 and BTB1 corresponds to the private BTB of thread1. However, as will be described below, selective sharing of BTBs between threads may allow for improved performance. BTBs 28 also includes a BTB0 control unit 64 which corresponds to BTB0, a BTB1 control unit 68 which corresponds to BTB1, and a global BTB control unit 70 which manages information from BTB0 control unit 64 and BTB1 control unit 68. BTB0 is bidirectionally coupled to BTB0 control unit 64 and provides a fullness indicator 0 to BTB0 control unit 64. BTB0 control unit 64 also receives T0BT1, thread1 en, thread ID, and BIA from CPU 30, and provides hit0, pred0, and BTA0 to global BTB control unit 70. BTB1 is bidirectionally coupled to BTB1 control unit 68 and provides a fullness indicator 1 to BTB1 control unit 68. BTB1 control unit 68 also receives T1BT0, thread0 en, thread ID, and BIA from CPU 30, and provides hit1, pred1, and BTA1 to global BTB control unit 70. Global BTB control unit 70 provides BTB hit indicator and BTB target address to CPU 30.

In operation, when no sharing is enabled or when both thread0 and thread1 are enabled, each of BTB0 and BTB1 operate as a private BTB for the corresponding thread. That is, branches from thread0 are stored only into BTB0 62 and branches from thread1 are stored only into BTB1 66. For example, those branches from thread0 which miss in BTB0 are allocated (e.g. stored) into BTB0. In doing so, the BTA and a prediction as to whether the branch is taken or not-taken is stored in an entry corresponding to the BIA of the branch instruction which missed. Similarly, those branches from thread1 which miss in BTB1 are allocated (e.g. stored) into BTB1 along with the corresponding BTA and prediction as to whether the branch is taken or not-taken. For each BIA submitted by CPU 30 to BTBs 28, each of the BTB control units perform a lookup in the corresponding BTB and provides a hit signal (hit0 or hit1), a corresponding prediction signal (pred0 or pred1), and a corresponding BTA (BTA0 or BTA1) to global BTB control unit 70. For example, if BTB0 control unit 64 determines that the received BIA matches an entry in BTB0, BTB0 control unit 64 asserts hit0 and provides pred0 and BTA0 from the matching entry of BTB0 to global BTB control unit 70. Similarly, if BTB1 control unit 68 determines that the received BIA matches an entry in BTB1, BTB1 control unit 68 asserts hit1 and provides pred1 and BTA1 from the matching entry of BTB1 to global BTB control unit 70.

Continuing with the above example, if hit0 is asserted and pred0 indicates the branch is predicted taken, global BTB control unit 70 asserts the BTB hit indicator and provides BTA0 as the BTB target address. If hit1 is asserted and pred1 indicates the branch is predicted taken, global BTB control unit 70 asserts the BTB hit indicator and provides BTA1 as the BTB target address. Note that if the corresponding prediction signal for an asserted hit signal from BTB0 or BTB1 indicates the branch is predicted as not taken, global BTB control unit 70 does not assert the BTB hit indicator and does not provide a BTB target address since a not-taken branch indicates the next instructions is fetched from the next sequential address. Also, if both BTB0 and BTB1 result in a hit such that both hit0 and hit 1 are asserted, global BTB control unit 70 uses the thread ID to determine which hit signal and prediction to use to provide the BTB hit indicator and BTB target address to CPU 30. That is, if the thread ID indicates thread 0, global BTB control unit 70 asserts the BTB hit indicator if pred0 indicates a taken prediction and provides BTA0 as the BTB target address.

However, in the case in which one of thread0 or thread1 is not enabled, its BTB can be selectively shared by the other thread. The T0BT1 and T1BT0 control bits may be used to indicate when a thread may borrow additional BTB entries from another thread's private BTB. For example, if T0BT1 is asserted and if thread0 is enabled but thread1 is not enabled, then, if needed, BTB0 control unit 64 may use an entry in BTB1 to allocate (e.g. store) a branch instruction from thread0. Similarly, if T1BT0 is asserted and if thread1 is enabled but thread0 is not enabled, then, if needed, BTB1 control unit 68 may use an entry in BTB0 to allocate (e.g. store) a branch instruction from thread1. In one embodiment, note that an entry in a BTB is allocated for each branch instruction which missed in the BTB (missed in both BTB0 and BTB1) and is later resolved as taken. In alternate embodiments, an entry in a BTB may be allocated for each branch instruction which misses in the BTB, regardless of whether it is resolved as taken or not taken.

In one embodiment, a thread may borrow entries from another thread's BTB only if borrowing is enabled from the other thread's BTB (such as by the borrow enable control bits) and the other thread is not enabled (i.e. is disabled). Also, in one embodiment, if a thread is allowed to borrow entries from another thread's BTB by the corresponding enable control bit, an entry in the other thread's BTB is only allocated if the BTB of the thread is full or has reached a predetermined fullness level. Therefore, each BTB may provide a fullness indicator (e.g. fullness indicator 0 or fullness indicator 1) to the corresponding BTB control unit. The predetermined fullness level may, for example, indicate a percentage of fullness of the corresponding BTB. In alternate embodiments, other or additional criteria may used to indicate when a thread allocates an entry in another thread's BTB, assuming borrowing is enabled for that thread.

In one embodiment, the prediction value stored in each BTB entry may be a two-bit counter value which is incremented to a higher value to indicate a stronger taken prediction or decremented to a lower value to indicator a weaker taken prediction or to indicate a not-taken prediction. Any other implementation of the branch predictor may be used. In an alternate embodiment, no prediction value may be present where, for example, branches which hit in a BTB may always be predicted taken.

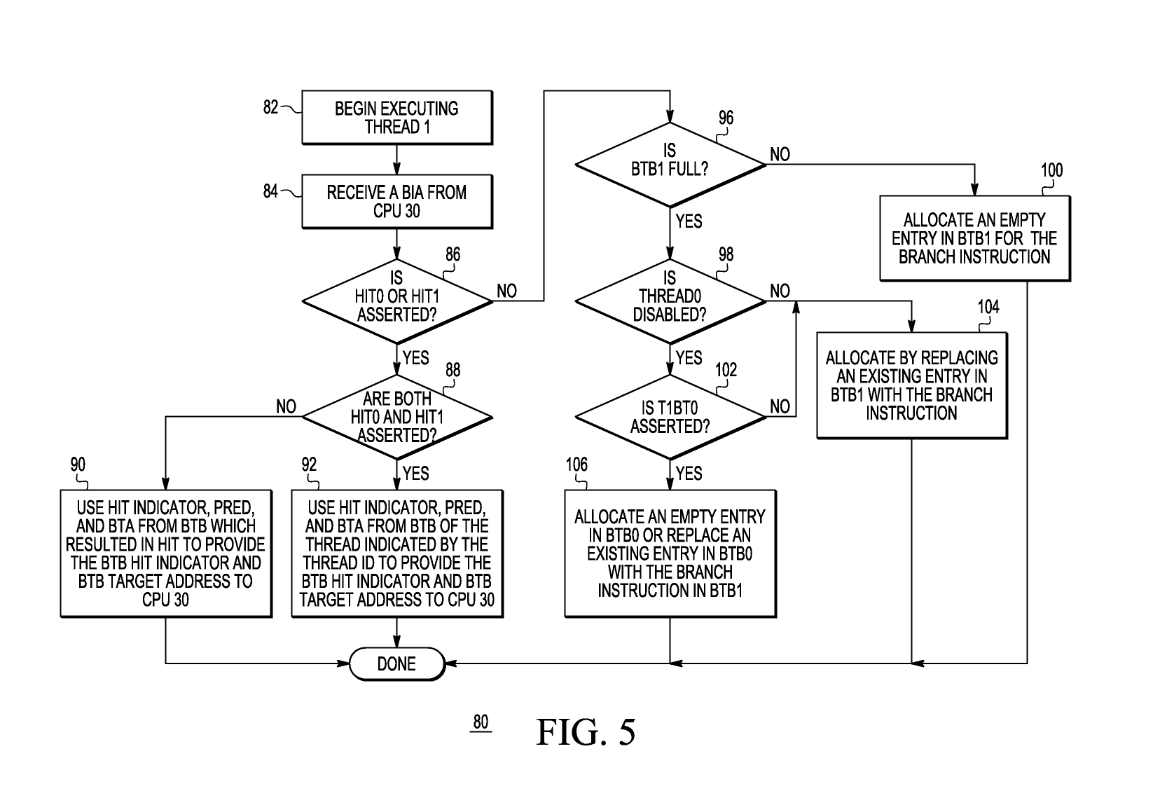

FIG. 5 illustrates, in flow diagram form, a method 80 of operation of BTBs 28 in accordance with one embodiment of the present invention. For method 80, it is assumed that thread1 is enabled, and thus thread1 en is asserted to a logic level 1. Method 80 begins with block 82 in which thread 1 begins execution. Therefore, thread control 56 of CPU 30 may select thread1 to execute. Method 80 then proceeds to block 84 in which a BIA is received from CPU 30. At decision diamond 86, it is determined whether hit0 or hit1 is asserted. As described above, the received BIA is provided to BTB0 control unit 64 and BTB1 control unit 68 so that each may perform a hit determination of BTA within BTB0 62 and BTB1 66, respectively. BTB0 control unit 64 provides hit0, pred0, and BTA0 to global BTB control unit 70 and BTB1 control unit 68 provides hit1, pred1, and BTA1 to global BTB control unit 70. If, at decision diamond 86, it is determined that at least one of hit0 or hit1 is asserted, method 80 proceeds to decision diamond 88 in which it is determined whether both hit0 and hit1 are asserted.

In the case in which both are not asserted, indicating that only one of hit0 or hit1 is asserted, method 80 proceeds to block 90 in which global BTB control unit 70 uses the hit indicator, prediction, and BTA from the BTB which resulted in the hit to provide the BTB hit indicator and BTB target address to CPU 30. For example, if hit0 is asserted and not hit1, then global BTB control unit 70 asserts the BTB hit indicator if pred0 indicates that the branch is predicted taken and provides BTA0 as the BTB target address. If hit1 is asserted and not hit0, then global BTB control unit 70 asserts the BTB hit indicator if pred1 indicates that the branch is predicted taken and provides BTA1 as the BTB branch target address. Method 80 then ends.

If, at decision diamond 88, it is determined that both hit0 and hit1 are asserted, method 80 proceeds to block 92 in which the hit indicator, prediction, and BTA from the BTB of the currently executing thread (indicated by the thread ID) is used to provide the BTB hit indicator and BTB target address to CPU 30. In this example, since thread1 is currently executing, thread ID indicates thread1. Therefore, global BTB control unit 70 asserts the BTB hit indicator if pred1 indicates that the branch instruction is taken and BTA1 is provided as the BTB target address. Method 80 then ends.

If, at decision diamond 86, neither hit0 nor hit1 is asserted, method 80 proceeds to decision diamond 96. If neither hit0 nor hit1 is asserted, then the received BIA resulted in a miss in each of BTB0 62 and BTB1 66. If the branch instruction is resolved (such as by execution unit(s) 48) to be a taken branch, then an entry in a BTB is to be allocated. Allocating an entry refers to storing the branch instruction in a BTB by either using an empty entry in which to store the branch instruction or, if an empty entry is not available, overwriting or replacing an existing entry. Any allocation policy may be used to determine which entry to replace, such as, for example, a least recently used policy, a pseudo least recently used policy, round robin policy, etc. Since the branch instruction which resulted in the misses in the BTBs is being executed within thread1, a new entry is to be allocated in BTB1 if possible. Therefore, at decision diamond 96, it is determined whether BTB1 66 is full. For example, thread ID indicates to BTB1 control unit 68 that thread1 is the currently executing thread, and fullness indicator 1 indicates whether BTB1 66 is full or not. If BTB1 is not full (or is less than a predetermined fullness level), method 80 proceeds to block 100 in which an empty entry in BTB1 66 is allocated for the branch instruction which resulted in the miss. The selected empty entry in BTB1 66 is updated with the BIA of the branch instruction, the branch target address of the branch instruction, and the prediction value of the branch instruction.

Referring back to decision diamond 96, if BTB1 is full (or is greater than a predetermined fullness level), method 80 proceeds to decision diamond 98 in which it is determined whether thread0 is disabled. If it is not disabled (meaning it is enabled and thus thread0 en is a logic level 1), method 80 proceeds to block 104 in which an entry in BTB1 is allocated for the branch instruction by replacing an existing entry in BTB1 with the branch instruction. As described above, any allocation policy may be used to determine which entry to replace. Note that since thread0 is enabled, thread1 is unable to borrow entries from its corresponding BTB, BTB0, regardless of whether borrow enable control bit T1BT0, and therefore has to replace an existing entry in its own BTB, BTB1. Method 80 then ends.

Referring back to decision diamond 98, if thread0 is disabled, method 80 proceeds to decision diamond 102 where it is determined whether T1BT0 is asserted (e.g. is a logic level one). If not, then method 80 proceeds to block 104 as described above. That is, even though thread0 is disabled, thread1 is unable to borrow entries from BTB0 because borrowing is not enabled by T1BT0. However, if at decision diamond 102, it is determined that T1BT0 is asserted, borrowing is enabled such that thread 1 may borrow entries from the BTB of thread0. Method 80 proceeds to block 106 in which an entry is allocated in BTB0 for the branch instruction. BTB0 control unit 64 therefore allocates an entry in BTB0 for the branch instruction from thread1 by either allocating an empty entry in BTB0 for the branch instruction if one is available or by replacing an existing entry in BTB0. Again, any allocation policy may be used by BTB0 control unit 64 to determine which entry to replace. The allocated entry will be updated to store the BIA of the branch instruction, the BTA of the branch instruction, and the corresponding prediction value. Method 80 then ends.

By now it should be appreciated that, in some embodiments, there has been provided a multi-threaded data processing system which includes private BTBs for use by each thread in which a thread may selectively borrow entries from the BTB of another thread in order to improve thread performance. In one embodiment, a thread is able to borrow entries from the BTB of another thread if its own BTB is full, the other thread is disabled, and BTB borrowing from the other thread's BTB is enabled. While the above description has been provided with respect to two threads, data processing system 10 may be capable of executing any number of threads, in which BTBs 28 would include more than 2 BTBs, one corresponding to each possible thread. The borrow enable control bits may be used to indicate whether borrowing is allowed, under the appropriate conditions, from a thread's private BTB.

As used herein, the term “bus” is used to refer to a plurality of signals or conductors which may be used to transfer one or more various types of information, such as data, addresses, control, or status. The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, a plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

The terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in one embodiment, the illustrated elements of data processing system 10 are circuitry located on a single integrated circuit or within a same device. Alternatively, data processing system 10 may include any number of separate integrated circuits or separate devices interconnected with each other. For example, memory 16 may be located on a same integrated circuit as processor 12 or on a separate integrated circuit or located within another peripheral or slave discretely separate from other elements of data processing system 10. Peripherals 18 and 20 may also be located on separate integrated circuits or devices. Also for example, data processing system 10 or portions thereof may be soft or code representations of physical circuitry or of logical representations convertible into physical circuitry. As such, data processing system 10 may be embodied in a hardware description language of any appropriate type.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the invention is described herein with reference to specific embodiments, various modifications and changes can be made without departing from the scope of the present invention as set forth in the claims below. For example, the number and configuration of the borrow enable control bits within control and status register 58 may be different dependent upon the number of threads capable of being executed by data processing system 10. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

The following are various embodiments of the present invention.

In one embodiment, a data processing system includes a processor configured to execute processor instructions of a first thread and processor instructions of a second thread; a first branch target buffer corresponding to the first thread, the first branch target buffer having a plurality of entries, each entry configured to store a branch instruction address and a corresponding branch target address; a second branch target buffer corresponding to the second thread, the second branch target buffer having a plurality of entries, each entry configured to store a branch instruction address and a corresponding branch target address; storage circuitry configured to store a borrow enable indicator corresponding to the second branch target buffer which indicates whether borrowing from the second branch target buffer is enabled; and control circuitry configured to allocate an entry for a branch instruction executed within the first thread in the first branch target buffer but not the second branch target buffer if borrowing is not enabled by the borrow enable indicator and in the first branch target buffer or the second branch target buffer if borrowing is enabled by the borrow enable indicator and the second thread is not enabled. In one aspect of the above embodiment, if borrowing is enabled by the borrow enable indicator and the second thread is not enabled, the control circuitry is configured to allocate an entry for the branch instruction in the first branch target buffer if the first branch target buffer is less than a predetermined fullness level. In another aspect, if borrowing is enabled by the borrow enable indicator and the second thread is not enabled, the control circuitry is configured to allocate an entry for the branch instruction in the second branch target buffer. In another aspect, if borrowing is enabled by the borrow enable indicator and the second thread is not enabled, the control circuitry is configured to allocate an entry for the branch instruction in the second branch target buffer if the first branch target buffer is at least at a predetermined fullness level. In another aspect, the control circuitry is further configured to allocate an entry for the branch instruction only in the first branch target buffer if borrowing is enabled by the borrow enable indicator and the second thread is enabled. In another aspect, the data processing system further includes a thread control unit configured to select an enabled thread from the first thread and the second thread for execution by the processor, wherein when the first thread is disabled, the thread control unit cannot select the first thread for execution and when the second thread is disabled, the thread control unit cannot select the second thread for execution. In another aspect, the control circuitry is further configured to receive branch instruction addresses from the processor, and for each branch instruction address, determine whether the branch instruction hits or misses in each of the first and the second branch target buffer. In a further aspect, the control circuitry is further configured to, when the branch instruction hits an entry in only one of the first or the second branch target buffer, provide the branch target address from the entry which resulted in the hit to the processor if the entry indicates a branch taken prediction. In another further aspect, the control circuitry is further configured to, when the branch instruction hits an entry in the first branch target buffer and hits an entry in the second branch target buffer, determine which of the first or the second thread is currently executing on the processor and to provide the branch target address to the processor from the entry of the branch target buffer which corresponds to the currently executing thread if that entry indicates a branch taken prediction. In another aspect of the above embodiment, the borrow enable indicator indicates whether borrowing is enabled for the first thread from the second branch target buffer. In a further aspect, the storage circuitry is further configured to store a second borrow enable indicator corresponding to the first branch target buffer which indicates whether borrowing is enabled for the second thread from the first branch target buffer. In another aspect, the branch instruction executed in the first thread corresponds to a branch instruction resolved as a taken branch by the processor.

In another embodiment, a data processing system configured to execute processor instructions of a first thread and processor instructions of a second thread and having a first branch target buffer corresponding to the first thread and a second branch target buffer corresponding to the second thread, a method includes receiving a branch instruction address corresponding to branch instruction being executed in the first thread; when the second thread is disabled and borrowing from the second branch target buffer is enabled, determining whether to allocate an entry for the branch instruction in the first branch target buffer or the second branch target buffer; and when borrowing from the second branch target buffer is not enabled, allocating an entry for the branch instruction in the first branch target buffer and not in the second branch target buffer. In one aspect, the second thread is disabled and borrowing from the second branch target buffer is enabled, the determining whether to allocate an entry for the first branch instruction address in the first branch target buffer or the second branch target buffer is based on fullness level of the first branch target buffer. In a further aspect, when the second thread is disabled and borrowing from the second branch target buffer is enabled, allocating an entry for the first branch instruction address in the first branch target buffer if the first branch target buffer is less than a predetermined fullness level and allocating an entry for the first branch instruction address in the second branch target buffer if the first branch target buffer is at least at the predetermined fullness level. In another aspect of the above embodiment, prior to the determining and the allocating, the method further includes performing a hit determination for the branch instruction address in the first branch target buffer and the second branch target buffer; in response to a hit of an entry in only one of the first or the second branch target buffer, providing the branch target address from the entry which resulted in the hit if the entry indicates a branch taken prediction; and in response to a hit of an entry in each of the first and the second branch target buffer, determining which of the first or the second thread is currently executing and providing the branch target entry from the entry of the branch target buffer which corresponds to the currently executing thread if that entry indicates a branch taken prediction. In a further aspect, the method further includes receiving a thread identifier, wherein the determining which of the first or the second thread is currently executing is performed based on the thread identifier. In another aspect of the above embodiment, prior to the determining and the allocating, the method further includes determining that the branch instruction misses in each of the first branch target buffer and the second branch target buffer; and resolving the branch instruction as a taken branch instruction.

In yet another embodiment, a data processing system configured to execute processor instructions of a first thread and processor instructions of a second thread and having a first branch target buffer corresponding to the first thread and a second branch target buffer corresponding to the second thread, a method includes receiving a branch instruction address corresponding to branch instruction being executed in the first thread; when the second thread is disabled and borrowing from the second branch target buffer is enabled, allocating an entry for the branch instruction in the first branch target buffer if the first branch target buffer is less than a predetermined fullness level and allocating an entry for the branch instruction in the second branch target buffer if the first branch target buffer is at least at the predetermined fullness level; and when borrowing from the second branch target buffer is not enabled, allocating an entry for the branch instruction in the first branch target buffer. In a further aspect, prior to the allocating, the method further includes determining that the branch instruction misses in each of the first branch target buffer and the second branch target buffer; and resolving the branch instruction as a taken branch instruction.

What is claimed is:

1. A data processing system, comprising:
a processor configured to execute processor instructions of a first thread and processor instructions of a second thread;
a first branch target buffer corresponding to the first thread, the first branch target buffer having a plurality of entries, each entry configured to store a branch instruction address and a corresponding branch target address;
a second branch target buffer corresponding to the second thread, the second branch target buffer having a plurality of entries, each entry configured to store a branch instruction address and a corresponding branch target address;
storage circuitry configured to store a borrow enable indicator corresponding to the second branch target buffer which indicates whether borrowing from the second branch target buffer is enabled; and
control circuitry configured to allocate an entry for a branch instruction executed within the first thread in the first branch target buffer but not the second branch target buffer if borrowing is not enabled by the borrow enable indicator and in the first branch target buffer or the second branch target buffer if borrowing is enabled by the borrow enable indicator and the second thread is not enabled.

2. The data processing system of claim 1, wherein, if borrowing is enabled by the borrow enable indicator and the second thread is not enabled, the control circuitry is configured to allocate an entry for the branch instruction in the first branch target buffer if the first branch target buffer is less than a predetermined fullness level.

3. The data processing system of claim 1, wherein, if borrowing is enabled by the borrow enable indicator and the second thread is not enabled, the control circuitry is configured to allocate an entry for the branch instruction in the second branch target buffer.

4. The data processing system of claim 1, wherein, if borrowing is enabled by the borrow enable indicator and the second thread is not enabled, the control circuitry is configured to allocate an entry for the branch instruction in the second branch target buffer if the first branch target buffer is at least at a predetermined fullness level.

5. The data processing system of claim 1, wherein the control circuitry is further configured to allocate an entry for the branch instruction only in the first branch target buffer if borrowing is enabled by the borrow enable indicator and the second thread is enabled.

6. The data processing system of claim 1, further comprising a thread control unit configured to select an enabled thread from the first thread and the second thread for execution by the processor, wherein when the first thread is disabled, the thread control unit cannot select the first thread for execution and when the second thread is disabled, the thread control unit cannot select the second thread for execution.

7. The data processing system of claim 1, wherein the control circuitry is further configured to receive branch instruction addresses from the processor, and for each branch instruction address, determine whether the branch instruction hits or misses in each of the first and the second branch target buffer.

8. The data processing system of claim 7, wherein the control circuitry is further configured to, when the branch instruction hits an entry in only one of the first or the second branch target buffer, provide the branch target address from the entry which resulted in the hit to the processor if the entry indicates a branch taken prediction.

9. The data processing system of claim 7, wherein the control circuitry is further configured to, when the branch instruction hits an entry in the first branch target buffer and hits an entry in the second branch target buffer, determine which of the first or the second thread is currently executing on the processor and to provide the branch target address to the processor from the entry of the branch target buffer which corresponds to the currently executing thread if that entry indicates a branch taken prediction.

10. The data processing system of claim 1, wherein the borrow enable indicator indicates whether borrowing is enabled for the first thread from the second branch target buffer.

11. The data processing system of claim 10, wherein the storage circuitry is further configured to store a second borrow enable indicator corresponding to the first branch target buffer which indicates whether borrowing is enabled for the second thread from the first branch target buffer.

12. The data processing system of claim 1, wherein the branch instruction executed in the first thread corresponds to a branch instruction resolved as a taken branch by the processor.

13. In a data processing system configured to execute processor instructions of a first thread and processor instructions of a second thread and having a first branch target buffer corresponding to the first thread and a second branch target buffer corresponding to the second thread, a method comprises:
receiving a branch instruction address corresponding to branch instruction being executed in the first thread;
when the second thread is disabled and borrowing from the second branch target buffer is enabled, determining whether to allocate an entry for the branch instruction in the first branch target buffer or the second branch target buffer; and
when borrowing from the second branch target buffer is not enabled, allocating an entry for the branch instruction in the first branch target buffer and not in the second branch target buffer.

14. The method of claim 13, wherein when the second thread is disabled and borrowing from the second branch target buffer is enabled, the determining whether to allocate an entry for the first branch instruction address in the first branch target buffer or the second branch target buffer is based on fullness level of the first branch target buffer.

15. The method of claim 14, wherein when the second thread is disabled and borrowing from the second branch target buffer is enabled, allocating an entry for the first branch instruction address in the first branch target buffer if the first branch target buffer is less than a predetermined fullness level and allocating an entry for the first branch instruction address in the second branch target buffer if the first branch target buffer is at least at the predetermined fullness level.

16. The method of claim 13, wherein prior to the determining and the allocating, the method further comprises:
performing a hit determination for the branch instruction address in the first branch target buffer and the second branch target buffer;
in response to a hit of an entry in only one of the first or the second branch target buffer, providing the branch target address from the entry which resulted in the hit if the entry indicates a branch taken prediction; and
in response to a hit of an entry in each of the first and the second branch target buffer, determining which of the first or the second thread is currently executing and providing the branch target entry from the entry of the branch target buffer which corresponds to the currently executing thread if that entry indicates a branch taken prediction.

17. The method of claim 16, further comprising receiving a thread identifier, wherein the determining which of the first or the second thread is currently executing is performed based on the thread identifier.

18. The method of claim 13, wherein prior to the determining and the allocating, the method further comprises:
determining that the branch instruction misses in each of the first branch target buffer and the second branch target buffer; and
resolving the branch instruction as a taken branch instruction.

19. In a data processing system configured to execute processor instructions of a first thread and processor instructions of a second thread and having a first branch target buffer corresponding to the first thread and a second branch target buffer corresponding to the second thread, a method comprises:
receiving a branch instruction address corresponding to branch instruction being executed in the first thread;
when the second thread is disabled and borrowing from the second branch target buffer is enabled, allocating an entry for the branch instruction in the first branch target buffer if the first branch target buffer is less than a predetermined fullness level and allocating an entry for the branch instruction in the second branch target buffer if the first branch target buffer is at least at the predetermined fullness level; and
when borrowing from the second branch target buffer is not enabled, allocating an entry for the branch instruction in the first branch target buffer.

20. The method of claim 19, wherein prior to the allocating, the method further comprises:
determining that the branch instruction misses in each of the first branch target buffer and the second branch target buffer; and
resolving the branch instruction as a taken branch instruction.
